(19) United States
(12) Patent Application Publication
(10) Pub. No.: US 2008/0284080 A1
(43) Pub. Date: Nov. 20, 2008

(54) APPARATUS FOR CHANGING WORKPIECE ATTITUDE AND METHOD FOR MANUFACTURING ARTICLE

(76) Inventors: Emiko Nakagawa, Yokohama-shi (JP); Masaaki Furuya, Yokohama-shi (JP); Masahiko Takahashi, Kamakura-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/120,570

(22) Filed: May 14, 2008

(30) Foreign Application Priority Data
May 15, 2007 (JP) 2007-129581

(51) Int. Cl. B23Q 1/25; B25B 11/00

(52) U.S. Cl. 269/71; 269/21

(57) ABSTRACT

A workpiece attitude change apparatus includes a first suction nozzle which includes a suction port, the suction port being able to suction a first surface of a workpiece, a second suction nozzle which has a predetermined inclination relative to the first suction nozzle, the second suction nozzle including a suction port, the suction port of the second suction nozzle being able to suction a second surface of the workpiece, and a vacuum pressure switch device for imparting a vacuum pressure to the first suction nozzle to cause the suction port of the first suction nozzle to suction the first surface of the workpiece, the vacuum pressure switch device stopping supply of the vacuum pressure to the first suction nozzle and imparting a vacuum pressure to the second suction nozzle to cause the suction port of the second suction nozzle to suction the second surface of the workpiece.

### CROSS-REFERENCE TO RELATED APPLICATIONS

This application is based upon and claims the benefit of priority from prior Japanese Patent Application No. 2007-129581, filed May 15, 2007, the entire contents of which are incorporated herein by reference.

### BACKGROUND OF THE INVENTION

1. Field of the Invention

The present invention relates to a workpiece attitude change apparatus and an article manufacturing method including the workpiece attitude change apparatus.

2. Description of the Related Art

Because the workpiece has at least two surfaces, the change of the workpiece attitude is required when the one of surface is processed after the process is performed to the other surface or when the arranged workpieces are taken out to change a direction in which the workpieces are arranged. Because various workpieces have various shapes, it is necessary to change the workpiece attitude according to various workpieces.

For example, Jpn. Pat. Appln. KOKAI Publication No. 03-279116 discloses a workpiece inverting apparatus. The workpiece inverting apparatus includes a suction pipe at a front end thereof in order to suction a circular workpiece, and two pawls provided in an inverting frame are opened and closed to nip the workpiece by an actuator. The inverting frame is turned around to be able to invert the workpiece.

Jpn. UM. Appln. KOKAI Publication No. 06-016341 discloses a suction apparatus suitable to the suction of a plate-like body having a curved surface. In the suction apparatus, a shaft of an auxiliary frame which suspends a suction pad through a slide member is attached into each lower surface of a fitting member inserted into an opening side-end portion of a main frame, and inclination means for rotating the auxiliary frame is attached to the fitting member.

However, desirably a shape, a structure, and an attitude change angle of the workpiece are not limited. In the workpiece inverting apparatus disclosed in Jpn. Pat. Appln. KOKAI Publication No. 03-279116, the workpiece is limited to the disc shape and the attitude of the workpiece is limited to the inversion of 180°. Although the suction apparatus disclosed in Jpn. UM. Appln. KOKAI Publication No. 06-016341 corresponds to the plate-like body having any curvature radius, the attitude change is not considered.

There is a workpiece which has a large length in a lengthwise direction while a section in a width direction has an extremely small rectangular shape. In processing this kind of workpiece, when the workpiece attitude is changed to orientate a second surface which is one of lengthwise and crosswise surfaces of the workpiece toward a predetermined direction after a first surface which is the other surface is processed, the workpiece cannot satisfactorily be handled with by the conventional techniques disclosed in Jpn. Pat. Appln. KOKAI Publication No. 03-279116 and Jpn. UM. Appln. KOKAI Publication No. 06-016341.

Specifically, for example, the workpiece has a depth of 1.0 mm, a width of 0.5 mm, and a length of 20 mm, and the workpiece is supplied while a longitudinal surface is orientated upward. It is necessary that the workpiece be picked up and carried out while a transverse surface is orientated upward in a predetermined region. In order to grasp and process this kind of workpiece with a mechanical apparatus, a highly precise apparatus is required because the workpiece is excessively small. In a manual operation, workability is significantly lowered.

### BRIEF SUMMARY OF THE INVENTION

The invention provides a workpiece attitude change apparatus comprising: a first suction nozzle which includes a suction port, the suction port being able to suction a first surface of a workpiece, the workpiece having a plurality of surfaces on planes different from each another; a second suction nozzle which has a predetermined inclination relative to the first suction nozzle, the second suction nozzle including a suction port on a plane different from the suction port of the first suction nozzle, the suction port of the second suction nozzle being able to suction a second surface of the workpiece; and a vacuum pressure switch device for imparting a vacuum pressure to the first suction nozzle to cause the suction port of the first suction nozzle to suction the first surface of the workpiece, the vacuum pressure switch device stopping supply of the vacuum pressure to the first suction nozzle and imparting a vacuum pressure to the second suction nozzle to cause the suction port of the second suction nozzle to suction the second surface of the workpiece, and the vacuum pressure switch device transferring the workpiece from the first suction nozzle to the second suction nozzle.

The invention further provides an article manufacturing method using a workpiece attitude change apparatus, the method comprising: suctioning a first surface of a workpiece by the workpiece attitude change apparatus, the workpiece attitude change apparatus comprising: a first suction nozzle which includes a suction port, the suction port being able to suction the first surface of the workpiece, the workpiece being placed in a predetermined attitude, the workpiece having a plurality of surfaces on planes different from each another; a second suction nozzle which has a predetermined inclination relative to the first suction nozzle, the second suction nozzle including a suction port on a plane different from the suction port of the first suction nozzle, the suction port of the second suction nozzle being able to suction a second surface of the workpiece; and a vacuum pressure switch device for imparting a vacuum pressure to the first suction nozzle to cause the suction port of the first suction nozzle to suction the first surface of the workpiece, the vacuum pressure switch device stopping supply of the vacuum pressure to the first suction nozzle and imparting a vacuum pressure to the second suction nozzle to cause the suction port of the second suction nozzle to suction the second surface of the workpiece, and the vacuum pressure switch device transferring the workpiece from the first suction nozzle to the second suction nozzle; imparting the vacuum pressure from the first suction nozzle to the second suction nozzle by the vacuum pressure switch device; and suctioning the workpiece by the suction port of the second suction nozzle to change an attitude of the workpiece.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a perspective view showing a workpiece suction state in a main part of a workpiece attitude change apparatus according to a first embodiment of the invention;

FIG. 1B is a perspective view showing a different workpiece suction state in the main part of the workpiece attitude change apparatus of the first embodiment;

FIG. 2 is a schematic view explaining workpiece attitude change in the workpiece attitude change apparatus of the first embodiment;

FIG. 3 is a schematic view showing a configuration of the workpiece attitude change apparatus of the first embodiment;

FIG. 4A is an explanatory view showing the workpiece attitude change apparatus of the first embodiment in a state in which an attitude of a workpiece is being changed;

FIG. 4B is an explanatory view showing the workpiece attitude change apparatus of the first embodiment in a state in which the attitude change of the workpiece is ended;

FIG. 5A is an explanatory view showing an issue with suction to the workpiece having a rectangular shape in section in the workpiece attitude change apparatus of the first embodiment;

FIG. 5B is an explanatory view showing an issue with suction to the workpiece having the rectangular shape in section in the workpiece attitude change apparatus of the first embodiment;

FIG. 5C is an explanatory view showing an solution of issue with suction to the workpiece having the rectangular shape in section in the workpiece attitude change apparatus of the first embodiment;

FIG. 6A is a partially sectional view showing a suction nozzle in which an opening area of a suction port is easily variable in the workpiece attitude change apparatus of the first embodiment;

FIG. 6B is a partially sectional view showing a different suction nozzle in which an opening area of a suction port is easily variable in the workpiece attitude change apparatus of the first embodiment;

FIG. 6C is a partially sectional view showing a different suction nozzle in which an opening area of a suction port is easily variable in the workpiece attitude change apparatus of the first embodiment;

FIG. 7 is an explanatory view showing workpiece attitude change in a workpiece attitude change apparatus according to a modification of the first embodiment;

FIG. 8 is an explanatory view showing workpiece attitude change in a workpiece attitude change apparatus according to a second embodiment of the invention;

FIG. 9 is a schematic view showing a configuration of the workpiece attitude change apparatus of the second embodiment;

FIG. 10A is an explanatory view showing workpiece attitude change in the workpiece attitude change apparatus of the second embodiment; and

FIG. 10B is an explanatory view showing workpiece attitude change in the workpiece attitude change apparatus of the second embodiment.

### DETAILED DESCRIPTION OF THE INVENTION

A first embodiment of the invention will be described with reference to the drawings.

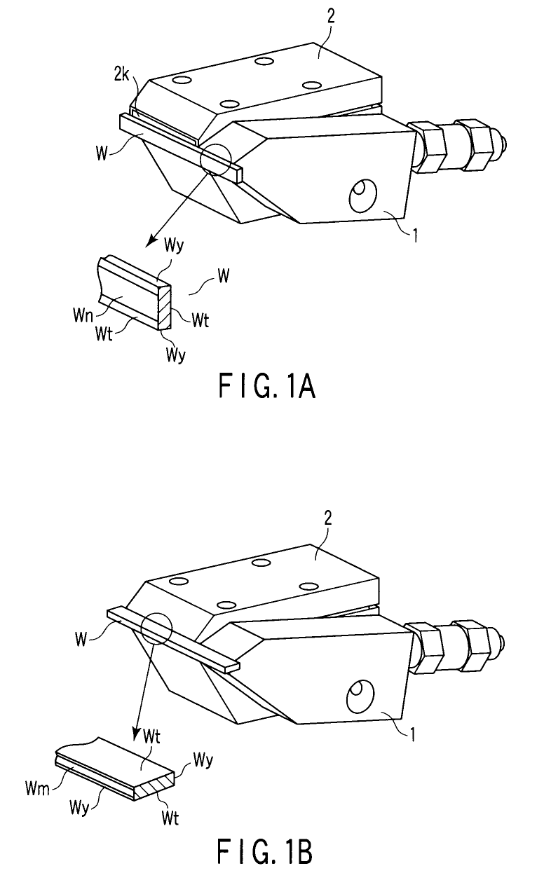

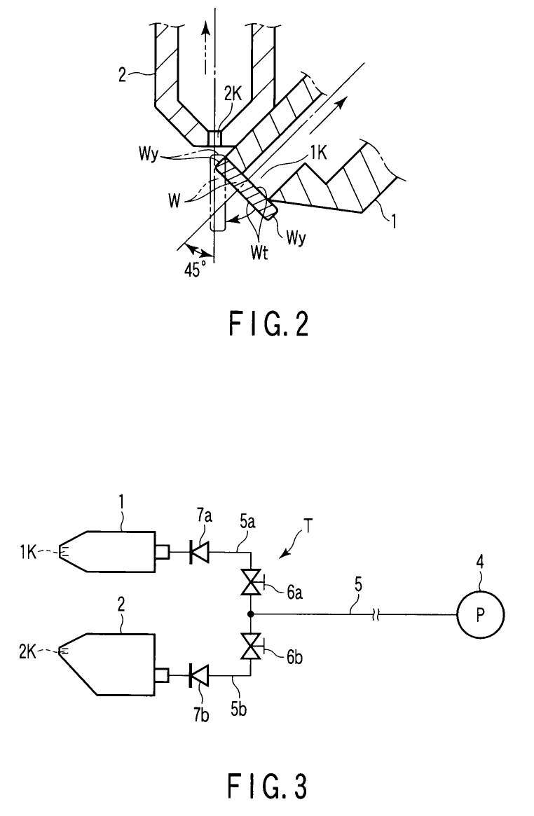

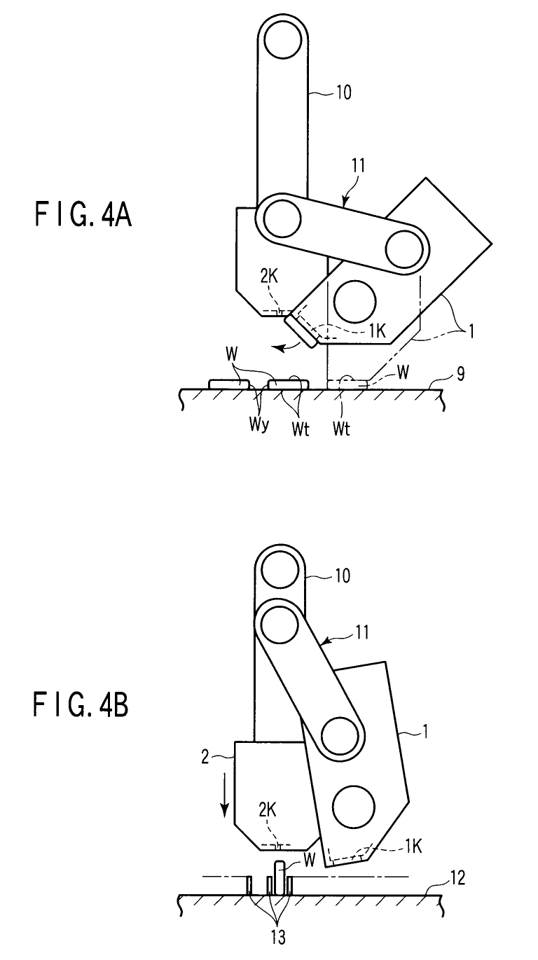

FIG. 1A is a perspective view showing a suction state of a workpiece W in a main part of a workpiece attitude change apparatus according to a first embodiment of the invention. FIG. 1B is a perspective view showing a different suction state of the workpiece W in the main part of the workpiece attitude change apparatus. FIG. 2 is a schematic view explaining attitude change of the workpiece W. FIG. 3 is a schematic view showing a configuration of the workpiece attitude change apparatus. FIG. 4A is an explanatory view showing the workpiece attitude change apparatus in a state in which an attitude of the workpiece W is being changed. FIG. 4B is an explanatory view showing the workpiece attitude change apparatus in a state in which the attitude change of the workpiece W is ended.

Referring to FIG. 3, the workpiece attitude change apparatus includes a first suction nozzle 1 and a second suction nozzle 2. The first and second suction nozzles 1 and 2 are disposed while being adjacent to each other.

The first and second suction nozzles 1 and 2 are connected to a vacuum pressure switch mechanism (a vacuum pressure switch device) T. The vacuum pressure switch mechanism T includes a vacuum pump 4 which is a suction source. A pipe 5 is connected to the vacuum pump 4, and the pipe 5 is branched into two-way branch pipes 5a and 5b in the mid point. The first and second suction nozzles 1 and 2 are connected to terminal portions of the branch pipes 5a and 5b.

A first on-off valve 6a and a first check valve 7a are provided in the branch pipe 5a connected to the first suction nozzle 1. A second on-off valve 6b and a second check valve 7b are provided in the branch pipe 5b connected to the second suction nozzle 2. As described later, the first and second on-off valves 6a and 6b are manually opened and closed at appropriate timing.

Alternatively, two electromagnetic on-off valves may be provided instead of the first and second on-off valves 6a and 6b, and electrically connected to a control unit to automatically perform the opening and closing control. Instead of the first and second on-off valves 6a and 6b, a three-way change-over valve may be provided in the branch portion of the pipe 5 extended from the vacuum pump 4.

As shown in FIGS. 1A and 1B, the workpiece W which becomes a target of the attitude change has plural surfaces on planes different from each other, that is, plural surfaces which are not located on the same plane. The workpiece W is formed into a minute rectangular-solid shape, for example, a rectangular-solid shape having a depth of 1.0 mm, a width of 0.5 mm, and a length of 20 mm. The workpiece W has the four surfaces except for both end faces. Hereinafter two longitudinal surfaces Wt of the workpiece W are referred to as “first surface” and two transverse surfaces Wy are referred to as “second surface”.

As shown in FIG. 4A, the workpieces W are placed on a supply tray 9 at predetermined intervals. One of the first surfaces Wt contacts the surface of the supply tray 9 and the other first surface Wt is orientated upward. Accordingly, the workpieces W are placed while the second surfaces Wy of the workpieces W face each other.

The workpiece attitude change apparatus includes a support rod 10 which can vertically be elevated and lowered, and the second suction nozzle 2 is attached to a lower end of the support rod 10. The attachment attitude of the second suction nozzle 2 is fixed to the support rod 10, and a suction port 2K provided at a front end of the second suction nozzle 2 is always orientated downward.

A link mechanism 11 is provided in the support rod 10, and the first suction nozzle 1 is attached to the link mechanism 11. The first suction nozzle 1 can be rotated by operating the link mechanism 11, and an orientation of a suction port 1K attached to a front end of the first suction nozzle 1 becomes variable.

Plural partition plates 13 are vertically provided at predetermined intervals in a carrying out tray 12 which accepts the workpieces W whose attitudes are changed.

The interval between the partition plates 13 is set such that the workpiece W can be inserted in the upright state.

Work for changing the attitude of the workpiece W using the workpiece attitude change apparatus aimed at the workpiece W will be described below.

Some pieces of article manufacturing apparatus including the workpiece attitude change apparatus have a machining unit for machining the workpiece W between the supply tray 9 and the carrying out tray 12, some pieces of the article manufacturing apparatus have the machining unit for machining the workpiece W in front of the carrying out tray 12, and the arranged workpieces W are taken out to change the direction in which the workpieces W are arranged in some pieces of the article manufacturing apparatus have the machining unit for machining the workpiece W.

The link mechanism 11 is operated to set the first suction nozzle 1 in the vertical attitude as shown in an alternate long and two short dashes line of FIG. 4A, and the suction port 1K is orientated downward to face the workpiece W whose attitude should be changed. Then, the support rod 10 is lowered to cause the suction port 1K of the first suction nozzle 1 to abut on the first surface Wt which is the longitudinal surface of the workpiece W orientated upward.

While the vacuum pump 4 is driven, the first on-off valve 6a is opened. A vacuum pressure acts on the suction port 1K of the first suction nozzle 1 to suction the first surface Wt of the workpiece W. When the support rod 10 is elevated at a predetermined timing, the workpiece W is separated from the supply tray 9 while suctioned by the first suction nozzle 1.

Then, the link mechanism 11 is operated to obliquely move the first suction nozzle 1. A stopper (not shown) regulates an oblique movement of the first suction nozzle 1 to retain the first suction nozzle 1 in the oblique attitude of about 45° as shown in full line. FIGS. 1A and 2 show this state. At the same time, the suction port 1K of the first suction nozzle 1 is brought close to the suction port 2K of the second suction nozzle 2.

The first and second suction nozzles 1 and 2 have predetermined inclinations, and the suction port 2K of the second suction nozzle 2 exists on a plane different from that of the suction port 1K of the first suction nozzle 1. In the workpiece W of FIG. 2, a corner portion of the first surface Wt suctioned by the suction port 1K of the first suction nozzle 1 and the second surface Wy on the upper-end side is brought close to the suction port 2K of the second suction nozzle 2.

At this point, the workpiece W is conveyed toward the carrying out tray 12 by operating the support rod 10. In the first suction nozzle 1, troubles such as the dropout and position shift of the workpiece W are not generated because the vacuum pressure acts sufficiently on the workpiece W.

Particularly, as shown in FIG. 1A, a range Wn shown in the first surface Wt of the workpiece W indicates one which is covered with the suction port 1K of the first suction nozzle 1. In the suction port 1K of the first suction nozzle 1, a size in a crosswise direction orthogonal to a lengthwise direction is set to a longitudinal size (1.0 mm) or less of the first surface Wt of the workpiece W.

The attitude of the workpiece W is changed in the middle of conveyance of the workpiece W to the carrying out tray 12 or in a region immediately above the carrying out tray 12. The closed second on-off valve 6b is opened, and the first on-off valve 6a is closed. The supply of the vacuum pressure to the first suction nozzle 1 is stopped as soon as the predetermined vacuum pressure acts on the suction port 2K of the second suction nozzle 2.

As described above, the first and second suction nozzles 1 and 2 are brought close to each other, the suction port 2K of the second suction nozzle 2 exists on a plane different from that of the suction port 1K of the first suction nozzle 1, and the corner portion of the first surface Wt and second surface Wy of the workpiece W is brought close to the suction port 2K of the second suction nozzle 2.

Accordingly, as shown by an alternate long and two dashes line of FIG. 2, the second surface Wy on the upper-end side of the workpiece W is suctioned by the suction port 2K of the second suction nozzle 2 as soon as the first surface Wt of the workpiece W is separated from the suction port 1K of the first suction nozzle 1. In the workpiece W, the upper-end-side second surface Wy is suctioned and fixed while the lower portion is freely hung.

Particularly, as shown in FIG. 1B, a range Wm shown in the second surface Wy of the workpiece W indicates one which is covered with the suction port 2K of the second suction nozzle 2. In the suction port 2K of the second suction nozzle 2, the size in the crosswise direction orthogonal to the lengthwise direction is set to the longitudinal size (0.5 mm) or less of the second surface Wy of the workpiece W.

In the first embodiment, the first on-off valve 6a is opened after the second on-off valve 6b is closed. Alternatively, the second on-off valve 6b may be closed after the first on-off valve 6a is opened. In either case, because the check valves 7a and 7b are provided between the suction nozzles 1 and 2 and the on-off valves 6a and 6b respectively, negative pressures remain in the suction nozzles 1 and 2 for a certain time, which allows the workpiece W to be suctioned and retained.

As shown in FIG. 4B, the support rod 10 is moved to a position immediately above the carrying out tray 12 and perpendicularly lowered to cause the workpiece W to face a predetermined accommodation region. The workpiece W is inserted between the partition plates 13, and then the second on-off valve 6b is closed. The workpiece W is released from the second suction nozzle 2 and placed in the upright state on the carrying out tray 12.

Thus, the workpiece W is placed on the supply tray 9 while the first surface Wt is orientated upward, and the workpiece W is suctioned by the first suction nozzle 1. Then, the workpiece W is transferred from the first suction nozzle 1 to the second suction nozzle 2, and the attitude of the workpiece W is changed at the same time. The attitude of the workpiece W is changed to the state in which the second surface Wy is orientated upward, and the workpiece W is placed on the carrying out tray 12.

Only the direction in which the negative pressure is generated is changed relative to the workpiece W, whereby the attitude of the workpiece W can smoothly be changed. Therefore, a time necessary for the attitude change is largely shortened to significantly improve the workability. Additionally, not only the complicated mechanism is not required, but also a rotation driving source such as a motor is not required, so that the assembly configuration can be simplified to provide the inexpensive apparatus.

In the first embodiment, the link mechanism 11 is provided to freely rotate the first suction nozzle 1. However, the invention is not limited to the first embodiment, but the first suction nozzle 1 may be simply rotatable. Alternatively, the first suction nozzle 1 may be fixed while the second suction nozzle 2 is rotatable.

In the first embodiment, the workpiece W is formed into the rectangular shape in section, and the workpiece W has the plural surfaces (four surfaces). Alternatively, the workpiece W may be formed into a polygonal shape in section, and the surface in the lengthwise direction is suctioned and rotated. In the first embodiment, the suction ports 1K and 2K of the suction nozzles 1 and 2 are formed smaller than the surfaces Wt and Wy of the workpiece W respectively. However, the invention is not limited to the first embodiment, but any suction port may be used as long as the workpiece W can surely be suctioned.

Alternatively, the support rod 10 and the first and second suction nozzles 1 and 2 may be unitized, and the units are provided in parallel at predetermined intervals to form an apparatus which can change the attitude of the workpiece having the extremely large length in the lengthwise direction.

The first and second suction nozzles 1 and 2 are connected to the same vacuum pump 4 through the pipe 5, and the same vacuum pressure acts on the first and second suction nozzles 1 and 2. In order to securely suction and retain the workpiece W, the vacuum pressure per unit area is set to the same value in the suction ports 1K and 2K of the first and second suction nozzles 1 and 2.

When the workpiece is suctioned using the vacuum pump having a relatively weak vacuum pressure, because the suction ports 1K and 2K of the suction nozzles 1 and 2 are formed smaller than the surfaces Wt and Wy of the workpiece W, the size in the lengthwise direction of the second suction nozzle suction port 2K suctioning the workpiece second surface Wy becomes inevitably longer than the size in the lengthwise direction of the first suction nozzle suction port 1K suctioning the workpiece first surface Wt.

However, it is necessary that the size in the crosswise direction of the suction port 2K of the second suction nozzle 2 be not more than 0.5 mm which is the longitudinal size of the second surface Wy of the workpiece W. Therefore, the following problems are generated.

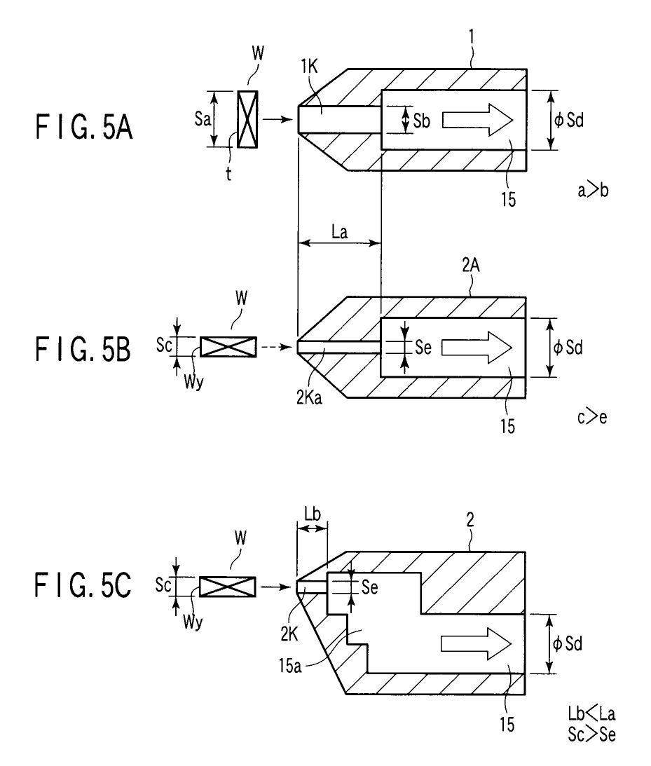

FIG. 5A is an explanatory view showing an issue with the suction to the workpiece W having the rectangular shape in section. FIG. 5B is an explanatory view showing an issue with the suction to the workpiece W having the rectangular shape in section. FIG. 5C is an explanatory view showing an issue with the suction to the workpiece W having the rectangular shape in section.

FIG. 5A shows a relationship between a longitudinal size Sa of the first surface Wt of the workpiece W and a crosswise direction size Sb of the suction port 1K of the first suction nozzle 1. As described above, the relationship of longitudinal size Sa>crosswise direction size Sb holds. A diameter φSd of a connecting hole 15 of the pipe 5 communicated with the vacuum pump 4 is a minimum necessary diameter.

Because the workpieces W are supplied while arranged on the supply tray 9, the front end of the suction nozzle 1 is tapered so as not contact the next workpiece W during the suction. Therefore, the length size Sa of the suction port 1K from the front end of the first suction nozzle 1 to the front end of the pipe connecting hole 15 is obtained and the predetermined vacuum pressure is applied to the workpiece W from the suction port 1K.

FIG. 5B shows a problem between a longitudinal size Sc of the workpiece second surface Wy and a crosswise direction size Se of a suction port 2Ka of a provisional second suction nozzle 2A. The second suction nozzle 2A is set to the same outer size as the first suction nozzle 1, the crosswise direction size Se of the suction port 2Ka is set to the longitudinal size Sc of the workpiece second surface Wy or less.

Assuming that the diameter φSd of the pipe connecting hole 15 is equal to the first suction nozzle 1, the same vacuum pressure as the first suction nozzle 1 is applied to the pipe connecting hole 15. On the other hand, the crosswise direction size Se of the suction port 2Ka provided in the second suction nozzle 2A is extremely short and the crosswise direction size Se is formed into a predetermined length La, which generates a large pressure loss in a boundary region between the front end of the pipe connecting hole 15 and the suction port 2Ka.

As a result, only a vacuum pressure smaller than the supplied vacuum pressure acts on the suction port 2Ka, and the vacuum pressure per unit area at the suction port 2Ka becomes lower than that at the first suction nozzle suction port 1K. Accordingly, possibly the workpiece W cannot be suctioned and retained in the suction port 2Ka of the second suction nozzle 2A, and the reliability is deteriorated.

FIG. 5C shows a structure of the second suction nozzle 2 in which the above-described problem is solved. The second suction nozzle 2 is formed longer than that of FIG. 5B along the vertical direction of FIG. 5C, and the front end of the second suction nozzle 2 is similarly tapered. Therefore, when the suction nozzle 2 suctions the workpiece W, the second suction nozzle 2 does not contact the next workpiece W.

The tapered front end is projected on upper side while the pipe connecting hole 15 is opened on the other lower side. Therefore, the pipe connecting hole 15 has a portion 15a where a number of bent portions are formed in the second suction nozzle 2, and the portion 15a constitutes a vacuum reservoir, that is, a buffer when the vacuum pressure is actually imparted from the vacuum pump 4.

The second suction nozzle 2 includes the buffer 15a by forming the middle portion of the pipe connecting hole 15 in the bent manner, thereby bringing the front end of the pipe connecting hole 15 close to the front end of the suction nozzle 2. Accordingly, a length size Lb of the suction port 2K provided from the front end of the second suction nozzle 2 to the front end of the pipe connecting hole 15 is shortened in comparison with the length size La of FIG. 5B.

The buffer 15a having the sufficient volume is formed in the pipe connecting hole 15, and the suction port 2K whose length size Lb is extremely shortened is provided while brought close to the buffer 15a. When the vacuum pressure acts actually on the second suction nozzle 2, the extremely small pressure loss is generated, and the sufficient vacuum pressure can act on the workpiece second surface Wy from the suction port 2K to securely suction the workpiece W.

As shown in FIGS. 1A and 1B, the second suction nozzle 2 is formed larger than the first suction nozzle 1, and the second suction nozzle 2 is formed longer than the first suction nozzle 1 along the lengthwise direction of the workpiece W. This is because the vacuum pressure per unit area is set to the same value in the suction ports 1K and 2K of the first and second suction nozzles 1 and 2.

The reason why the size in the lengthwise direction of the second suction nozzle 2 is formed larger than that of the first suction nozzle 1 is that, as described above with reference to FIGS. 5A, 5B, and 5C, the buffer 15a is provided in the pipe connecting hole 15 of the second suction nozzle 2 to shorten the length size Lb of the suction port 2K, thereby decreasing the pressure loss to ensure the vacuum pressure to the workpiece W.

The vacuum pressure of the vacuum pump 4 which acts on the first and second suction nozzles 1 and 2 is adjusted in order to securely suction the workpieces W having the different sizes and shapes using the first and second suction nozzles 1 and 2. However, for example, a regulator and a control component for controlling the regulator are required as a vacuum pressure adjusting device, which results in the cost for components increase.

Opening areas of the suction ports 1K and 2K are variable in the first and second suction nozzles 1 and 2 instead of the vacuum pressure adjusting device. However, the suction nozzles 1 and 2 are formed in the same size while only the opening areas of the suction ports 1K and 2K differ from each other, which also results in the cost increase.

The suction nozzle which has no influence on the cost will be described below.

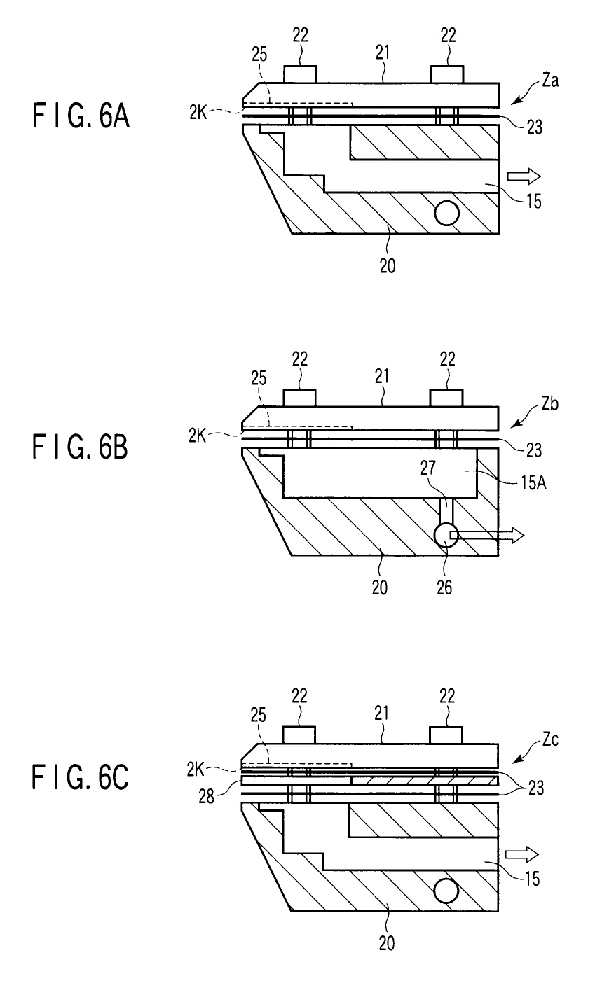

FIG. 6A is a partially sectional view showing a suction nozzle Za in which the opening area of the suction port 2K is easily variable. FIG. 6B is a partially sectional view showing a different suction nozzle Zb in which the opening area of the suction port 2K is easily variable. FIG. 6C is a partially sectional view showing a different suction nozzle Zc in which the opening area of the suction port 2K is easily variable.

The suction nozzle of FIG. 6 is formed into the same outer shape as the second suction nozzle 2 of FIG. 5C, however, the suction nozzle of FIG. 6 can also be applied to the first suction nozzle 1.

The suction nozzle Za of FIG. 6A includes a nozzle body 20 and a nozzle cover 21. The nozzle cover 21 is attached to the nozzle body 20 with bolts 22 which are a fixing member. A packing 23 is interposed between the nozzle body 20 and the nozzle cover 21.

The pipe connecting hole 15 is provided in the nozzle body 20, the front end of the pipe connecting hole 15 is provided only to the region near the front end of the nozzle body 20, and the pipe connecting hole 15 is opened to an upper surface of the nozzle body 20. On the other hand, a groove portion 25 is provided in a lower surface of the nozzle cover 21. The groove portion 25 has a predetermined height and a width corresponding to a width of the upper-surface opening of the pipe connecting hole 15 of the nozzle body.

The rear end of the groove portion 25 is aligned with the rear end of the pipe connecting hole 15, and the front end of the groove portion 25 is provided beyond the front end of the pipe connecting hole 15 to the front end of the nozzle cover 21. The packing 23 is formed into the same shape as the whole surface of the nozzle cover 21 except for the groove portion 25. The nozzle cover 21 fixed to the upper surface of the nozzle body 20 closely contacts the upper surface of the nozzle body 20 with the packing 23 interposed therebetween.

That is, in the assembled state, the groove portion 25 of the nozzle cover 21 constitutes a space portion for the upper surface of the nozzle body 20, and the front end of the groove portion 25 constitutes the suction port 2K. Accordingly, the completed suction nozzle Za becomes similar to the suction nozzle of FIG. 5C, and there is no trouble with the suction nozzle Za from the viewpoint of action.

Plural kinds of the nozzle covers 21 whose groove portions 25 have different heights (depths) are prepared to change the opening area of the suction port 2K, and the specifications can be satisfied by replacing the suction nozzle Za to optimum one according to the required opening area of the suction port 2K. At least the nozzle body 20 can be standardized.

Alternatively, the nozzle cover 21 whose groove portion 25 has the one kind of the height may be prepared. That is, the suction nozzle Za whose suction port 2K has the minimum opening area is prepared, and the number of pieces of packing 23 interposed between the nozzle body 20 and the nozzle cover 21 is increased according to the specifications.

Although the size in the lengthwise direction of the suction port 2K is not changed, the size in the crosswise direction becomes larger, and therefore the opening area of the suction port 2K can be changed according to the number of pieces of packing 23. Accordingly, the suction port 2K having the optimum opening area can be selected according to the workpiece W.

In the suction nozzle Zb of FIG. 6B, because the nozzle cover 21 and the packing 23 are identical to those of the suction nozzle Za, the nozzle cover 21 and the packing 23 are designated by the same numbers and the description is omitted. A base-end portion of a pipe connecting hole 15A made in the nozzle body 20 is not opened to the rear end face of the nozzle body 20, and the pipe connecting hole 15A is made at a position away from the rear end face by a predetermined distance.

The suction nozzle Zb is supported by a support member (not shown), and a support pipe is used as the support member. A hole portion 26 through which the support pipe pierces and a hole portion 27 communicated with the pipe connecting hole 15A are made in the nozzle body 20. A hole portion communicated with the hole portion 26 is also made in the support pipe, and a branch pipe 5b extended from the vacuum pump 4 is connected to one end portion of the support pipe.

In the suction nozzle Zb, similarly to the suction nozzle Za of FIG. 6A, the size in the crosswise direction of the suction port 2K is changed by changing the number of pieces of packing 23, which allows the opening area of the suction port 2K to be adjusted. Additionally, not only the configuration of the piping with the vacuum pump 4 can be simplified, but also the rotating operation of the suction nozzle Zb is smoothly performed to further improve the reliability.

The suction nozzle Zc of FIG. 6C has the configuration basically identical to that of the suction nozzle Za of FIG. 6A. In the suction nozzle Zc, in order to diversify the size in the crosswise direction of the suction port 2K, a spacer (shim) 28 and the pieces of packing 23 are interposed between the nozzle body 20 and the nozzle cover 21. The spacer 28 is interposed between the pieces of packing 23. The spacer 28 is formed by a thin metal plate, and the spacer 28 is formed into the same shape and size as the packing 23.

When the plural spacers 28 having different thicknesses are prepared, the suction ports 2K having various opening areas can be obtained by selecting the spacers 28 having the necessary thickness. Alternatively, the suction ports 2K having various opening areas may be set by alternately attaching the pieces of packing 23 and the spacers 28 having the same thickness. Therefore, the suction nozzle having the simpler configuration has an extremely small influence on the cost.

In the case where the pieces of packing 23 stacked, the packing 23 is easily collapsed and deformed in a piercing portion of the bolt 22, while the packing 23 is easily swelled and deformed in other portions. As a result, a sealing property is possibly deteriorated between the pieces of packing 23. On the other hand, when the spacer 28 formed by the metal plate is interposed between the pieces of packing 23, there is generated no trouble with the sealing property of the packing 23.

In the first embodiment, the first suction nozzle 1 suctions the longitudinal surface of the workpiece W having the rectangular shape in section as the first surface Wt, and the second suction nozzle 2 suctions the transverse surface of the workpiece W as the second surface Wy. That is, the workpiece W is carried out while the attitude of the supplied workpiece W is changed by 90°. However, the invention is not limited to the first embodiment.

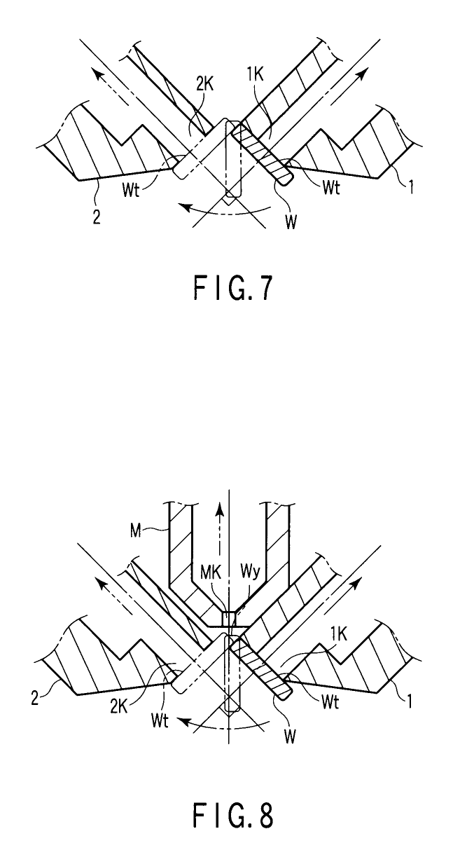

FIG. 7 is an explanatory view showing the state in which the attitude of the workpiece W is changed by 180°.

In FIG. 7, the first suction nozzle 1 is located on the right while the second suction nozzle 2 is located on the left, the first suction nozzle 1 suctions the first surface Wt of the workpiece W, and the workpiece W is transferred to the second suction nozzle 2. Ideally the first and second suction nozzles 1 and 2 are brought close to each other while an angle of about 90° is formed between the center axes of the first and second suction nozzles 1 and 2.

That is, the first and second suction nozzles 1 and 2 are brought close to each other, the suction port 2K of the second suction nozzle 2 exists on the plane different from that of the suction port 1K of the first suction nozzle 1, and the corner portion between the first surface Wt and second surface Wy of the workpiece W is brought close to the suction port 2K of the second suction nozzle 2.

The supply of the vacuum pressure to the first suction nozzle 1 is stopped and the supply of the vacuum pressure to the second suction nozzle 2 is started. At this point, the switching timing is selected as described above. Because the check valves 7a and 7b are interposed between the suction nozzles 1 and 2 and the on-off valves 6a and 6b respectively, the workpiece W is smoothly transferred from the first suction nozzle 1 to the second suction nozzle 2.

The workpiece W is carried out to a predetermined region while the first surface Wt of the workpiece W is suctioned by the second suction nozzle 2. In the workpiece W existing on the supply tray 9, the first surface Wt on one side is suctioned and picked up by the first suction nozzle 1, and then the first surface Wt on the other side is suctioned by the second suction nozzle 2 to place the workpiece W on the carrying out tray 12. Therefore, the attitude of the workpiece W is changed by 180°.

In the workpiece attitude change apparatus, the attitude of the workpiece W is changed by 180° at a stroke. On the other hand, in order to surely prevent the dropout of the workpiece W in the middle of the change, the attitude of the workpiece W is tentatively changed by an intermediate angle, and the attitude is changed to 180°. A second embodiment of the invention will be described with reference to FIGS. 8 to 10B.

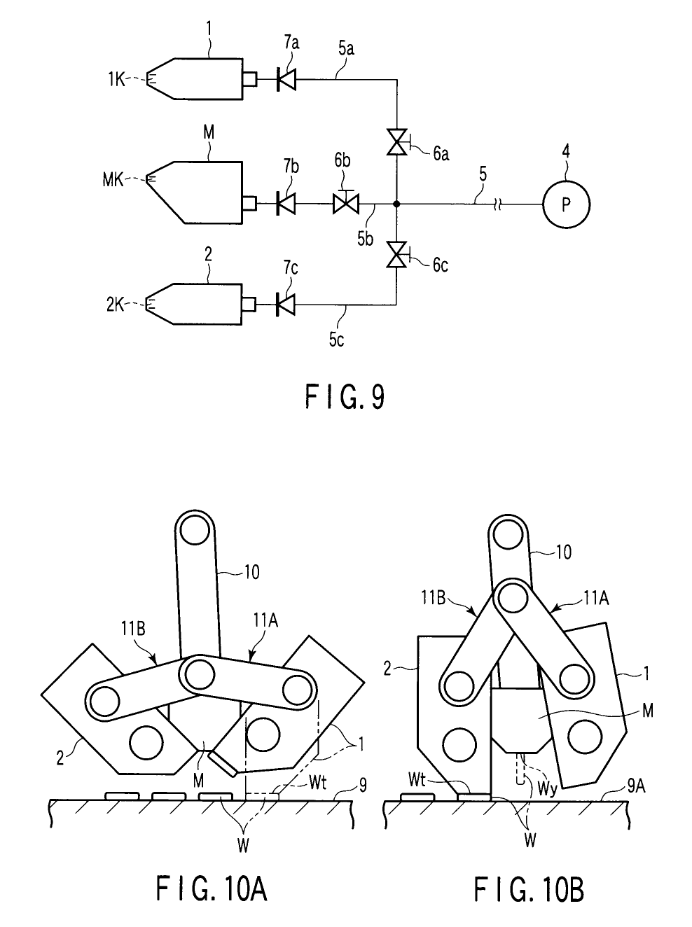

FIG. 8 is an explanatory view showing the state in which the workpiece W is transferred. FIG. 9 is a schematic view showing a configuration of the workpiece attitude change apparatus of the second embodiment. FIG. 10A is an explanatory view showing the state in which the attitude of the workpiece W is being changed, and FIG. 10B is an explanatory view showing the state in which the attitude change of the workpiece W is ended.

As shown in FIG. 8, the workpiece attitude change apparatus includes the first suction nozzle 1, an intermediate suction nozzle M, and the second suction nozzle 2. In the second embodiment, the first suction nozzle 1 and the second suction nozzle 2 have the same configuration as the first suction nozzle 1 of the first embodiment, and the intermediate suction nozzle M has the same configuration as the second suction nozzle 2 of the first embodiment.

The target workpiece W has a size (depth of 1.0 mm×width of 0.5 mm×length of 20 mm). As mentioned later, the first suction nozzle 1 and the second suction nozzle 2 suction the first surface Wt which is the longitudinal surface of the workpiece W, and the intermediate suction nozzle M suctions the second surface Wy which is the transverse surface of the workpiece W.

As shown in FIG. 9, the suction nozzles 1, M, and 2 are communicated through the pipe 5 with the vacuum pump 4 which is the suction source. The pipe 5 connected to the vacuum pump 4 is branched into three ways in the middle, the first on-off valve 6a and the first check valve 7a are provided in the branch pipe 5a, and the branch pipe 5a is communicated with the first suction nozzle 1.

The second on-off valve 6b and the second check valve 7b are provided in the branch pipe 5b, and the branch pipe 5b is communicated with the intermediate suction nozzle M. A third on-off valve 6c and a third check valve 7c are provided in a branch pipe 5c, and the branch pipe 5c is communicated with the second suction nozzle 2. The first to third on-off valves 1 to 3 are a manual on-off valve. Alternatively, an electromagnetic on-off valve may be used to automatically perform the opening and closing control.

As shown in FIGS. 10A and 10B, the intermediate suction nozzle M is attached to the lower end of the support rod 10 which can be elevated and lowered. The attachment attitude of the intermediate suction nozzle M is fixed to the support rod 10, and a suction port MK of the intermediate suction nozzle M is always orientated downward.

Two link mechanisms 11A and 11B are attached to the support rod 10 while projected horizontally. The first suction nozzle 1 is attached to the link mechanism 11A, and the plural second suction nozzles 2 are attached to the link mechanism 11B.

The first and second suction nozzles 1 and 2 can be rotated by operating the link mechanisms 11A and 11B, and the attitude positions of the first and second suction nozzles 1 and 2 can be retained. That is, orientations of suction ports 1K and 2K provided in the first and second suction nozzles 1 and 2 are adjusted according to the rotation attitudes of the suction nozzles 1 and 2.

The actual attitude change work with the workpiece attitude change apparatus will be described below.

Some pieces of article manufacturing apparatus including the workpiece attitude change apparatus have a machining unit for machining the workpiece W between the supply tray 9 and the carrying out tray 9A, some pieces of the article manufacturing apparatus have the machining unit for machining the workpiece W in front of the carrying out tray 9A, and the arranged workpieces W are taken out to change the direction in which the workpieces W are arranged in some pieces of the article manufacturing apparatus have the machining unit for machining the workpiece W.

As shown in FIG. 10A, the workpieces W are arranged, the first surfaces Wt on one side of the workpieces W are placed on the supply tray 9, and the first surfaces Wt on the other side are orientated upward. The first suction nozzle 1 is set in the perpendicular attitude, and the suction port 1K of the first suction nozzle 1 is orientated downward to face the workpiece W which should be suctioned. The support rod 10 is moved downward, the suction port 1K of the first suction nozzle 1 is caused to abut on the first surface Wt of the workpiece W.

The vacuum pump 4 is driven while the first on-off valve 6a is opened. The vacuum pressure acts on the suction port 1K of the first suction nozzle 1 to suction the first surface Wt of the workpiece W. When the support rod 10 is elevated at a predetermined timing, the workpiece W is separated from the supply tray 9 while suctioned by the first suction nozzle 1.

Then, the link mechanism 11A is operated to obliquely move the first suction nozzle 1, and the first suction nozzle 1 is retained in the oblique attitude of about 45°. FIG. 8 shows this state. The first suction nozzle 1 and the intermediate suction nozzle M are brought close to each other, and the suction port MK of the intermediate suction nozzle M exists on the plane different from that of the suction port 1K of the first suction nozzle 1. The corner portion between the first surface Wt and second surface Wy of the workpiece W is brought close to the suction port MK of the intermediate suction nozzle M.

The support rod 10 is further operated to convey the workpiece W to the carrying out tray 9A. In the first suction nozzle 1, troubles such as the dropout and position shift of the workpiece W are not generated during the conveyance or processing because the vacuum pressure acts sufficiently on the workpiece W.

The attitude of the workpiece W is changed in the middle of the conveyance of the workpiece W to the carrying out tray 9A or in a region immediately above the carrying out tray 9A. The second on-off valve 6b is opened, and then the first on-off valve 6a is closed. The second surface Wy of the workpiece W is suctioned by the suction port MK of the intermediate suction nozzle M as soon as the first surface Wt of the workpiece W is separated from the suction port 1K of the first suction nozzle 1.

At this point, the intermediate suction nozzle M and the second suction nozzle 2 are brought close to each other, the suction port 2K of the second suction nozzle 2 exists on the plane different from that of the suction port MK of the intermediate suction nozzle M, and the corner portion between the second surface Wy and first surface Wt of the workpiece W is brought close to the suction port 2K of the second suction nozzle 2.

Then, the second on-off valve 6b is closed after the third on-off valve 6c is opened. The first surface Wt of the workpiece W is suctioned by the second suction nozzle suction port 2K as soon as the second surface Wy of the workpiece W is separated from the intermediate suction nozzle suction port MK. However, the first surface Wt of the workpiece W suctioned by the second suction nozzle 2 is opposite the first surface Wt previously suctioned by the first suction nozzle 1.

The support rod 10 is moved to the position immediately above the carrying out tray 9A and perpendicularly lowered, and the third on-off valve 6c is closed. The workpiece W is released from the second suction nozzle 2 and placed on the carrying out tray 9A. Thus, because the workpiece W is tentatively set in the intermediate attitude before the attitude of the workpiece W is changed by the predetermined angle (180°), the attitude change is smoothly performed.

Not only the complicated mechanism is not required, but also a rotation driving source such as a motor is not required, so that the assembly configuration can be simplified to provide the inexpensive apparatus. Only the direction in which the negative pressure is generated is changed relative to the workpiece W, whereby the attitude of the workpiece W can appropriately and smoothly be changed. Therefore, a time necessary for the attitude change is largely shortened to significantly improve the workability.

The invention is not limited to the above embodiments, but the attitude change angle relative to the workpiece W can appropriately be set. That is, in the implementation stage, various modifications can be made without departing from the scope of the invention. Additionally, various modifications can be made by an appropriate combination of the components disclosed in the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A workpiece attitude change apparatus comprising:
a first suction nozzle which includes a suction port, the suction port being able to suction a first surface of a workpiece, the workpiece having a plurality of surfaces on planes different from each another;
a second suction nozzle which has a predetermined inclination relative to the first suction nozzle, the second suction nozzle including a suction port on a plane different from the suction port of the first suction nozzle, the suction port of the second suction nozzle being able to suction a second surface of the workpiece; and
a vacuum pressure switch device for imparting a vacuum pressure to the first suction nozzle to cause the suction port of the first suction nozzle to suction the first surface of the workpiece, the vacuum pressure switch device stopping supply of the vacuum pressure to the first suction nozzle and imparting a vacuum pressure to the second suction nozzle to cause the suction port of the second suction nozzle to suction the second surface of the workpiece, and the vacuum pressure switch device transferring the workpiece from the first suction nozzle to the second suction nozzle.

2. The workpiece attitude change apparatus according to claim 1, wherein the vacuum pressure switch device includes a check valve such that a negative pressure remains in each suction nozzle for a certain time while the supply of the vacuum pressure to the first suction nozzle or the second suction nozzle is stopped.

3. The workpiece attitude change apparatus according to claim 1, wherein at least one of the first suction nozzle and the second suction nozzle includes a buffer which guides the vacuum pressure to the suction port after tentatively accumulating the vacuum pressure supplied from the vacuum pressure switch device.

4. The workpiece attitude change apparatus according to claim 1, wherein at least one of the first suction nozzle and the second suction nozzle is branched in a suction port portion while being able to be exchanged, and at least one spacer is detachably interposed between the branched portions.

5. The workpiece attitude change apparatus according to claim 1, comprising an auxiliary suction nozzle which is interposed between the first suction nozzle and the second suction nozzle to suction and support the workpiece in intermediate attitude between a workpiece suction attitude of the first suction nozzle and a workpiece suction attitude of the second suction nozzle.

6. The workpiece attitude change apparatus according to claim 1, wherein the vacuum pressure switch device starts the supply of the vacuum pressure to the second suction nozzle before stopping the supply of the vacuum pressure to the first suction nozzle suctioning the workpiece, when the workpiece is transferred from the first suction nozzle to the second suction nozzle.

7. An article manufacturing method using a workpiece attitude change apparatus, said method comprising:
suctioning a first surface of a workpiece by the workpiece attitude change apparatus, the workpiece attitude change apparatus comprising: a first suction nozzle which includes a suction port, the suction port being able to suction the first surface of the workpiece, the workpiece being placed in a predetermined attitude, the workpiece having a plurality of surfaces on planes different from each another; a second suction nozzle which has a predetermined inclination relative to the first suction nozzle, the second suction nozzle including a suction port on a plane different from the suction port of the first suction nozzle, the suction port of the second suction nozzle being able to suction a second surface of the workpiece; and a vacuum pressure switch device for imparting a vacuum pressure to the first suction nozzle to cause the suction port of the first suction nozzle to suction the first surface of the workpiece, the vacuum pressure switch device stopping supply of the vacuum pressure to the first suction nozzle and imparting a vacuum pressure to the second suction nozzle to cause the suction port of the second suction nozzle to suction the second surface of the workpiece, and the vacuum pressure switch device transferring the workpiece from the first suction nozzle to the second suction nozzle;
imparting the vacuum pressure from the first suction nozzle to the second suction nozzle by the vacuum pressure switch device; and
suctioning the workpiece by the suction port of the second suction nozzle to change an attitude of the workpiece.
